(19) United States
(12) Patent Application Publication
(10) Pub. No.: US 2018/0295825 A1
(43) Pub. Date: Oct. 18, 2018

(54) SNUBBERLESS SPINCAST REEL

(71) Applicant: Pure Fishing, Inc., Spirit Lake, IA (US)

(72) Inventors: Cameron Ivie, Irmo, SC (US); Wu Lao, Guangzhou, Guangdong (CN)

(21) Appl. No.: 15/569,488

(22) PCT Filed: Apr. 27, 2016
(86) PCT No.: PCT/US2016/029557

§ 371 Date: Oct. 26, 2017

Related U.S. Application Data
(60) Provisional application No. 62/153,454, filed on Apr. 27, 2015.

(51) Int. Cl. A01K 89/01

(52) U.S. Cl. CPC A01K 89/01029; A01K 89/0113

(57) ABSTRACT

A spincast reel having at least one camming control member device that is operably connected to the activation button and the pickup pin camming control member device to control the extension and retraction of the pickup pin during casting, unspooling, and retrieving operations of the reel.

This application claims priority to co-pending U.S. Provisional Patent Application Ser. No. 62/153,454 filed on Apr. 27, 2015 and entitled “Snubberless Spincast Reel”, the disclosure of which is hereby incorporated by reference.

### FIELD OF THE INVENTION

The present disclosure relates to fishing equipment and more particularly to an improved fishing reel, such as a closed face reel or spincast reel, designed to reduce the friction and wear on the fishing line during operation of the reel, such as when casting the line from the reel.

### BACKGROUND

Fishing reels are well known in the art and include the basic bait casting reels, spinning reels, and spincast reels. Numerous improvements have been directed to the fishing reel, including U.S. Pat. Nos. 3,074,664, 4,408,729, 5,427,325, 5,782,419, 6,375,107, 6,394,379, 6,572,043, 6,843,439, and 7,344,099.

Spincast reels are one type of fishing reels that are well known in the art. Spincast reels can typically include a central body, or reel frame, to which front and rear covers can be attached. A foot structure extends from either the bottom of the frame, or back cover when present, and is used to secure the reel to a fishing rod. A casting button operably projects from the frame, or back cover when present, and is user activated to facilitate control of the fishing line during casting. A crank handle extends from the side of the fishing reel for retrieval of the fishing line around a line spool contained within the front cover of the reel.

The reel frame includes a spool hub supporting the line spool on which the fishing line is wound. The line spool is normally stationary, but can be controllably rotatable in response to tension placed on the fishing line. A pickup head, or rotor, is mounted forward of the line spool and winds the fishing line around the spool when rotated by the crank handle. Typically, the pickup head will be configured with one or more pickup slots and one or more selectively retractable pickup pins positioned in the slots and extendable on the outer periphery of the pickup head. The pickup pins are designed to engage the fishing line as the pickup head is rotated by the handle. This engagement of the pickup pin and the fishing line winds the fishing line around the line spool.

The front cover, or front cone, of a spincast reel is configured to surround and cover both the line spool and the pickup head. The fishing line itself extends over the pickup head from the spool, traversing the pickup head in the space between the pickup head and the inner surface of the front cover. The fishing line exits through a central opening at the forward end of the front cover.

In the operation of a conventional spincast reel, a user, or angler, activates the casting button, or thumb button, to begin the casting process. As the button is pushed, the pickup pin is moved inside the pickup head and disengages from the fishing line. Activation of the button also moves the pickup head axially forward with respect to the frame along a central shaft. This movement of the pickup head presses, or snubs, the fishing line against the inside of the front cover. This action is designed to hold the fishing line in place during the initial portion of the casting process. During the casting process, this “snubbing” takes the place of the pickup pin and its function of not allowing movement of the fishing line. Basically, in a conventional spincast reel, depression of the button acts like a friction brake and restricts movement of the fishing line. This brake is predicated on the pressure of the pickup head squeezing the fishing line against the inside surface of the front cover. As the user continues the casting motion, the thumb button is released whereby the pickup head moves axially backwards, allowing the fishing line to freely flow from the reel.

As generally seen in prior art FIG. 1 from U.S. Pat. No. 3,074,664, a conventional reel 1 has a button 2 that can be depressed by the angler to push shaft 3 forward and move snubbing pad 4 and against fishing line 5 against an inside contact surface 6 of front cover 7.

The snubbing of the line between the rotor and front cone can cause damage to the fishing line, including thinning or flattening of the fishing line at the pressure location, as well as unnecessary abrasion from sand, grit and suspended fines drawn into the reel with retrieved fishing line. These sources of damage can potentially result in a broken line and lost lures or fish. Furthermore, as the weight of the bait, lures, bobbers, added weights, etc. being cast increases, an angler must produce more pressure on the thumb button during casting to prevent the fishing line from sliding between the pickup head and the front cover before the thumb button is released. This added pressure can be difficult for some anglers and can complicate the casting process.

All patents and publications described or discussed herein are hereby incorporated by reference in their entireties.

What is needed then are improvements to a fishing reel to reduce the wear on the fishing line used therein. Preferably the reel appears to operate similarly, or substantially identical, in the hands of the user. This needed reel is lacking in the art.

### SUMMARY OF THE INVENTION

It is a general object of the invention to provide an improved spincast fishing reel.

Yet another object of the current disclosure is to provide an improved spincast reel with a line control system that reduces the friction, abrasion, and/or pressure on a fishing line during the casting process.

Still another object of the current disclosure is to provide a mechanical line control system that reduces at least some of the wear and tear on a fishing line experienced during the casting process of that fishing line from a reel.

Numerous other objects, features, and advantages of the present disclosure will be readily apparent to those skilled in the art upon a reading of the following description when taken in conjunction with the accompanying drawings

In accordance with these objects and others that will become apparent from the description herein, the present invention provides a spincast reel system and a method for its use in which the reel system includes:

(a) a frame

(b) a spool connected to the frame for holding fishing line;

(c) a central shaft operably connected to the frame;

(d) a pickup head operably rotatably mounted to the central shaft, the rotor including a pickup pin positionable between a first position on the outer periphery of the rotor and a second position on the inner periphery of the rotor, where the pickup pin in the first position will engage the fishing line to prevent the fishing line from unwinding from the spool when the rotor is not rotating and wind the fishing line onto the spool when the rotor is rotating, and where the pickup pin in the second position allows the fishing line to unwind from the spool;

(e) a thumb button operative attached to the frame, the thumb button linked to the pickup pin by a mechanical system;

(f) the mechanical system configured and positioned to maintain the pickup pin in the first position when the thumb button is pressed forward; and

(g) the mechanical system configured and positioned to move the pickup pin to the second position when the thumb button is released.

Preferably, the mechanical system includes a camming control member device having at least one cam surface, said cam device being operably connected to the activation button and the pickup pin. The camming control member device and the crank shaft are positioned and configured with at least one camming surface to interact with suitable at least one biased armature to retract and extend the pickup pin for selective engagement with the fishing line during operation of the reel.

In a preferred embodiment the reel further includes a biased connection rod that operably connects the activation button and the camming control member device. A connection bracket is operably positioned between and connecting the activation button and the connection rod. A camming support is operably positioned between the activation button and the camming control member device wherein the camming support is positioned to facilitate the transfer of an axial displacement force between the activation button and the camming control member device to control the radial position of the pickup pin during the casting, unspooling, and retrieving operations.

The use of the cam-based mechanical system of the present invention controls the pickup pin position that provides a control system for the fishing line that avoids the use of snubber-based compression against the inside of the reel cover and reduced opportunities for contaminants to be rubbed against the fishing line. The result is a line control system that is less damaging to the fishing line and that is operationally transparent for the angler.

### BRIEF DESCRIPTION OF THE DRAWINGS

FIG. 1 is a cross-sectional view of a prior art spincast reel that snubs the line against the inside of the front cover to secure the fishing line during a cast.

FIG. 2 is an isometric, external view of a reel made in accordance with the current disclosure.

FIG. 3 is a top view of a reel without the front cover.

FIG. 4 is a side view of a reel without its cover and showing the pickup pin extending outside the pickup head.

FIG. 5 is a view like that of FIG. 4 but with the pickup pin retracted inside the pickup head to allow fishing line to unwind from the spool.

FIG. 6 is a side view of a reel made in accordance with the current disclosure showing the camming control member device mechanism in the first or initial position.

FIG. 7 is a like that of FIG. 6 but showing the line-retaining, mid-position of the camming support and the camming control member device with the reel button is pushed in preparation for a cast.

FIG. 8 is like that of FIG. 7 with the camming control member device and camming support in the casting position with the pickup pin retracted.

FIG. 9 is a perspective view like that of FIG. 6 showing the reel in the first position.

FIG. 10 is a perspective view of the reel in FIG. 7 showing the camming control member device in the line-retaining, mid-position for a cast.

FIG. 11 is a perspective view of the reel in FIG. 8 showing the camming control member device in the second or retracted position as line unwinds during a cast.

FIG. 12 is an isolated parts view similar to FIGS. 6 and 9 with the mechanism in the first position with an extended pickup pin for line winding.

FIG. 13 is an isolated parts view similar to that of FIGS. 7 and 10 showing the camming control member device and armatures in the line-retaining, mid-position for casting.

FIG. 14 is an isolated parts view like that of FIGS. 8 and 11 when the pickup pin is retracted for unwinding line during a cast.

FIG. 15 is a perspective view of the camming control member device showing the cams, ramps, and shelf surfaces that are involved with pickup pin extension and retraction.

FIG. 16 is a side view of the camming control member device.

FIG. 17 is an isolated parts view showing the displacement parts between the push button and the cam support within the reel.

FIG. 18 shows an alternate embodiment of the invention.

FIG. 19 depicts an activated view of the embodiment of FIG. 18.

FIG. 20 shows yet another alternate embodiment of the invention.

FIG. 21 shows the actuated position of the embodiment of FIG. 20.

FIG. 22 illustrates armature connections under the pickup head.

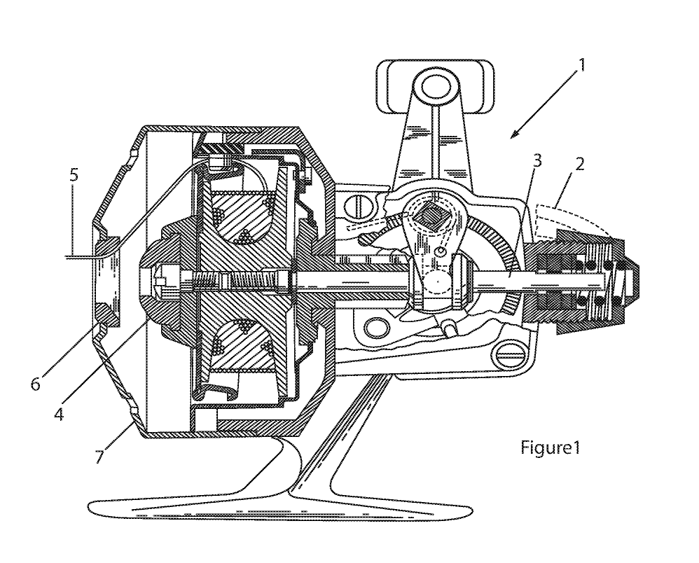

### DETAILED DESCRIPTION

The spincast reel of the invention eliminates the use of the conventional snubber system and implements a cam-actuated control system for a retractable winding pin. With a unidirectional crank, this system restrains the fishing line against the winding pin during a cast, withdraws the winding pin to allow line to unspool during the cast, and re-engages the winding pin for retrieving the cast line and lure. Such a mechanism eliminates the use of a snubber system to restrain the fishing line against the inside of the cover during the casting operation and the issues that attend such snubber systems.

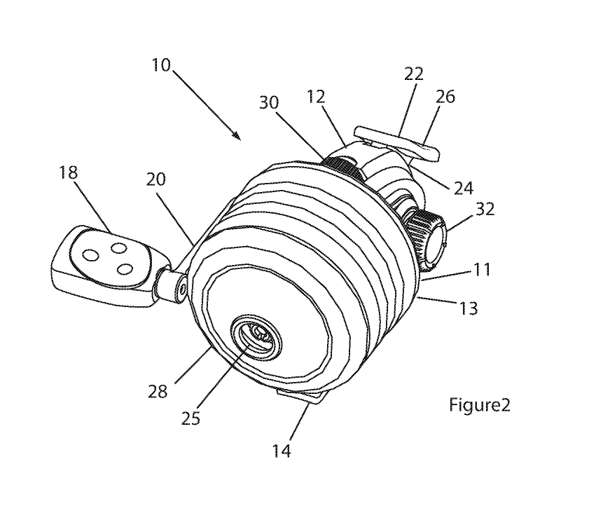

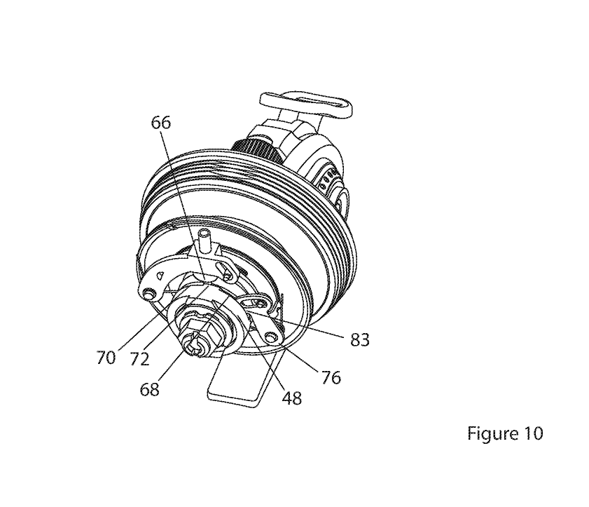

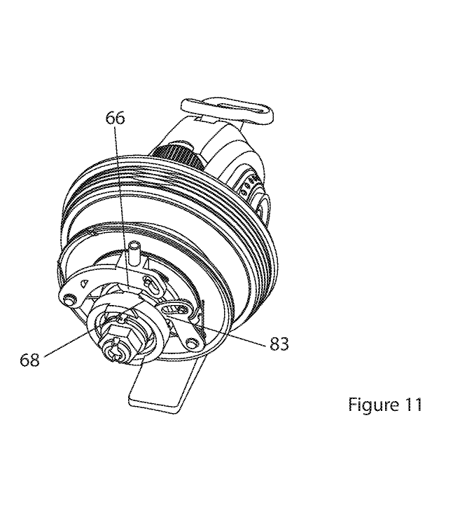

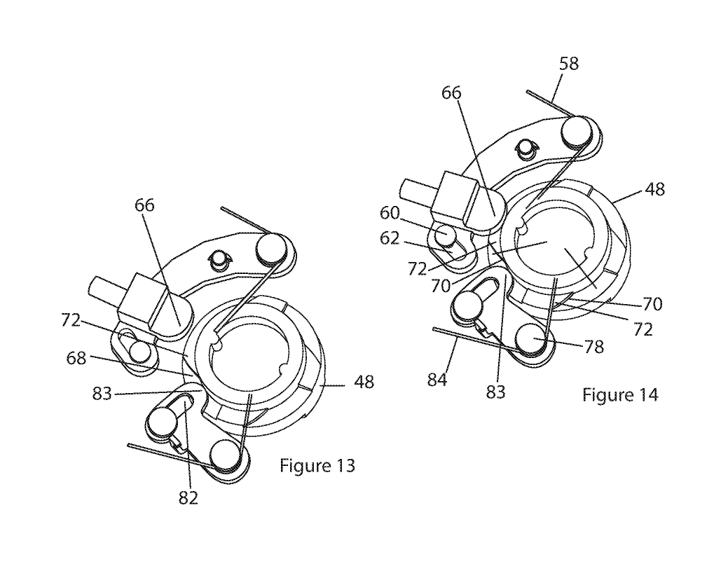

The invention is most conveniently described with reference to FIGS. 2-17 in which a preferred embodiment of the present disclosure provides a reel generally designated by the numeral 10. It is understood that, for the sake of clarity, not all reference numbers are included in each drawing and that use of the same reference number is intended to convey that the element is the same as another similarly number.

In addition, positional terms such as a “upper,” “lower,” “side,” “top,” “bottom,” “vertical,” “horizontal,” etc. refer to the apparatus when in the orientations shown in the drawing. The skilled artisan will recognize that objects in accordance with the present disclosure can assume different orientations when in use.

As generally seen in FIGS. 2-5, reel 10 includes a frame 12 that is used to support a majority of the elements of reel 10. Frame 12 includes a foot 14 that is used to connect the reel 10 to a fishing pole or fishing rod (not shown). The reel 10 and a rod are used in conjunction with a fishing line 16. A crank handle 18 is connected to a crank arm 20, which is operatively connected to the frame 12 and to central shaft 36 by connections that are conventional in the art. See U.S. Pat. Nos. 2,724,563; 2,974,534; 2,776,803; 6,375,107; 6,641,070; and 6,726,137, the disclosures of which are hereby incorporated by reference. Reel 10 further includes drag adjustment 30 and a crank handle fastener 32.

A thumb activation button 22 is pivotably supported by frame 12 and extends rearward toward the angler's hand (not shown) from a back side 11 of the frame 12. The thumb button 22 includes a button armature 24 connecting the contact surface 26 to the frame 12. The contact surface 26 is what an angler engages, or depresses, to hold fishing line 16 and begin the casting process.

The front side 13 of the frame 12 includes a front cover 28, typically conical in shape. The connection of the front cover 28 to the frame 12 can be by threads, slots, and grooves, and other releasable type fasteners, including frictional or mechanical type fasteners, as known in the art. The front cover 28 includes an opening 25 through which the fishing line 16 extends and is retrieved during the casting and winding processes, respectively.

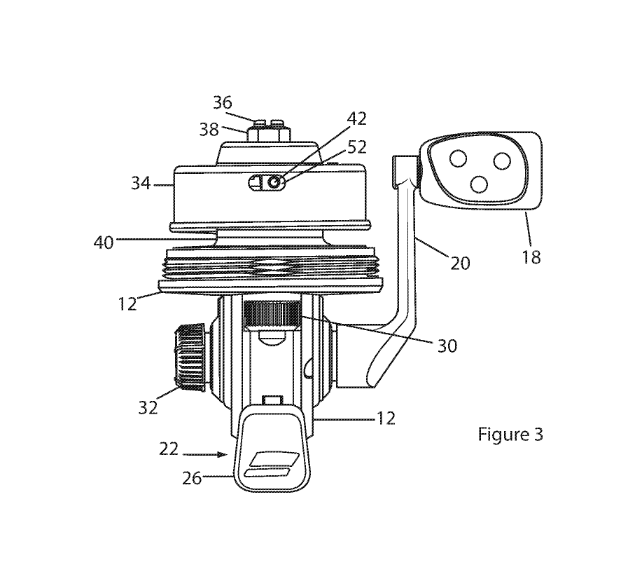

As best seen in FIGS. 3-5, reel 10 includes a pickup head 34, also known as a rotor, underneath the front cover 28. Pickup head 34 is operatively attached to the central shaft 36, such as by a fastener 38, which can be a traditional nut fastener, or other fasteners known in the art. The pickup head 34 can include an opening 35 that accepts the central shaft 36 wherein the fastener 38 connects the pickup head 34 and central shaft 36 at a threaded terminal end on central shaft 36.

The central shaft 36 is operatively connected to the crank handle 18, and more particularly the crank armature 20, through various gears and bearings as known in the art. This establishes that a turn of the crank handle 18 will at least partially rotate the pickup head 34, which facilitates winding of the fishing line 16 around stationary spool 40.

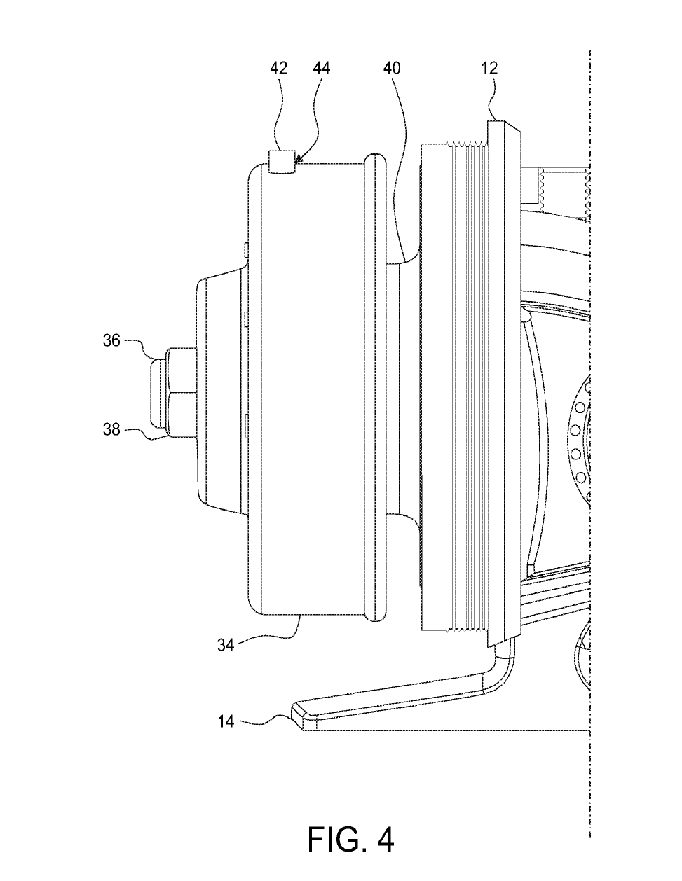

Pickup head 34 includes a pickup pin 42 that can extend through a slot 44 in the pickup head 34. Pickup pin 42 is positionable in a first position for winding, as shown in FIG. 4, such that the pickup pin 42 extends out of the opening 44 of the pickup head 34. In this position, pickup pin 42 can engage the fishing line 16 so that when an angler turns crank handle 18, central shaft 36 rotates along with pickup head 34 and pickup pin 42 so that pickup pin 42 engages the fishing line 16 and winds fishing line 16 around spool 40. Fishing line 16 is held against pickup pin 42 by tension on fishing line 16 as well as a relatively tight tolerance between the end of pickup pin 42 and the inside surface of front cover 28 when pickup pin 42 is in the first position, or extended position.

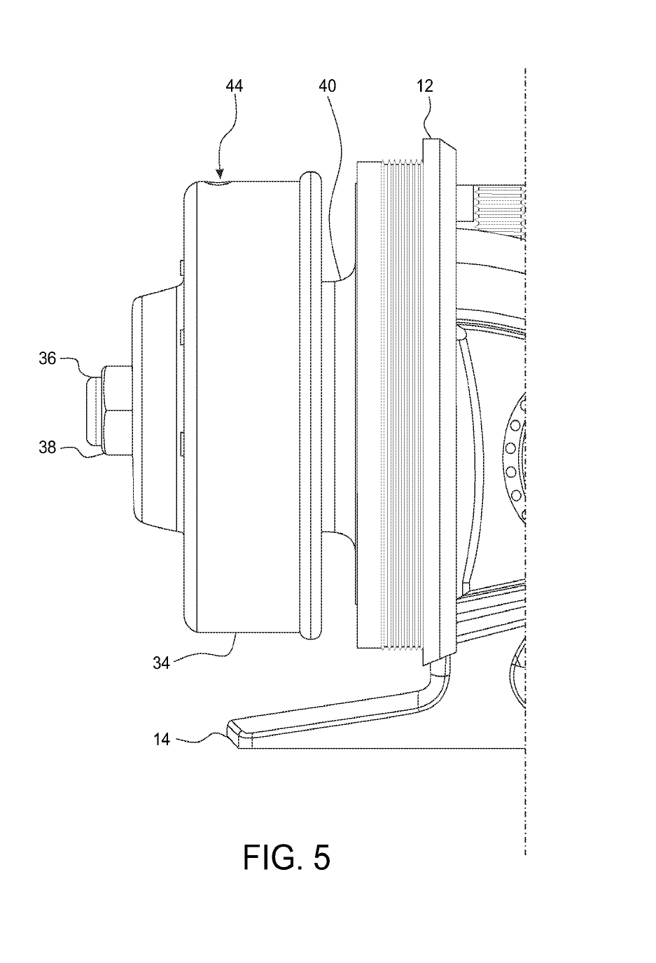

In a second position, such as the unwinding position shown in FIG. 5, pickup pin 42 is substantially recessed, and preferably entirely recessed, within the outer surface of pickup head 34. In this position, pickup pin 42 will not engage fishing line 16 thereby allowing fishing line 16 to unwind from the spool 40 and extend out of opening 25. The retraction of pickup pin 42 allows the fishing line 16 to use the full width of the space between pickup head 34 and the inside surface of front cover 28 during the unwinding process.

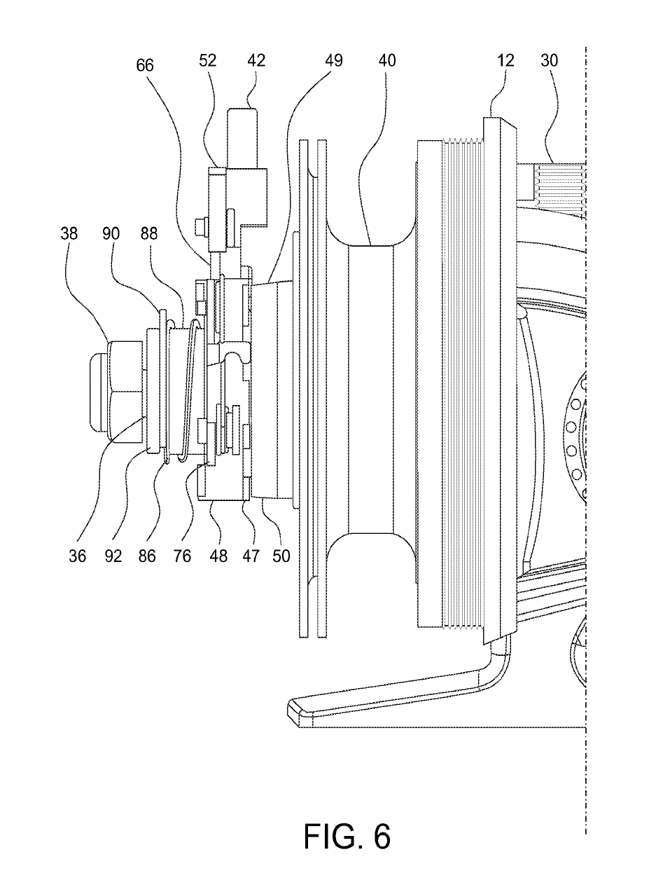

As shown in FIGS. 6-14, a cam-based mechanical system controls the extension and retraction of pickup pin 42 by engagement of a pickup armature with at least one of the camming surfaces on the rear side of a camming control member device 48. This cam-based mechanical control system includes interactions among camming control member device 48, camming support 50, pickup armature 52, connection rod 54, connection bracket 56, bracket guides 57, rod return spring 55, cam return spring 86, bearing 88, and clip 90.

Pickup armature 52 is attached to the inside surface 33 of pickup head 34 by a screw or any of the various fasteners that are known in the art. Pickup armature 52 is pivotably secured at a proximal end with pin 64 and exhibits a generally arcuate shape towards distal end 53 that exhibits slot 62 and radially inward first protrusion 66. Biasing element 58 urges inward first protrusion 66 radially inward and against the external surface of camming element 48. Pin 60 extends through slot 62 and limits the arcuate displacement of pickup armature 52 as inward first protrusion 66 engages the external surface features of camming control member device 48.

Pickup pin 42 is attached to pickup armature 52 with a threaded fastener that extends through pin 42 into a threaded hole in armature 52. Pickup armature 52 and pickup pin 42 are attached in a manner that facilitates rotational movement of the pickup pin 42 to minimize frictional drag against the outer surface of pickup pin 42. As the external surface features of camming element 48 act on pickup armature 52, pickup pin 42 is extended and retracted from pickup head 34 (see FIGS. 4 and 5).

Pickup armature 52 rotates about pin 64 within the limits set by translation pin 60 in slot 62. Pickup armature 52 includes radially inward first protrusion 66 that engages camming control member device 48 and reacts to its surface features to move pickup pin 42 in and out of the slot 44 as the surface of camming control member device moves radially outwardly or inwardly, respectively.

A positioning armature 76 is used to help stabilize and position components of mechanical system 46. Positioning armature 76 has a proximal end 79 with hole 81 for pivot pin 78 and a distal end 82 having a second, radially inward, rounded protrusion 83, outer rounded protrusion 85, and biasing element catch arm 87. Second biasing element 84 engages catch arm 87 and urges positioning armature against camming control member device 48 by pivoting around pivot pin 78 within the arcuate limits of the movement of slot pin 80 in slot 77.

Preferably, the axial and any rotational translation movements of the connection bracket 56, connection rod 54, camming support 50 and camming control member device 48 in mechanical system 46 are independent of central shaft 36 such that the overall position of any elements of mechanical system 46 that are positioned proximate to the central shaft 36 can move axially and rotationally independently of central shaft 36. To this end, bearing 88 is positioned around central shaft 36 and rotationally separates camming support 50 and camming control member device 48 from central shaft 36 so that the rotation of central shaft 36 is independent of any rotational movement of camming control member device 48 and camming support 50. The movement of the mechanical system 46 preferably does not move the central shaft 36, pickup head 34, or fastener 38 in an axial direction—either towards or away from the front cover 28. This keeps the pickup head 34 from pressing the fishing line 16 against the inside surface 29 of the front cover 28 when the activation button is depressed.

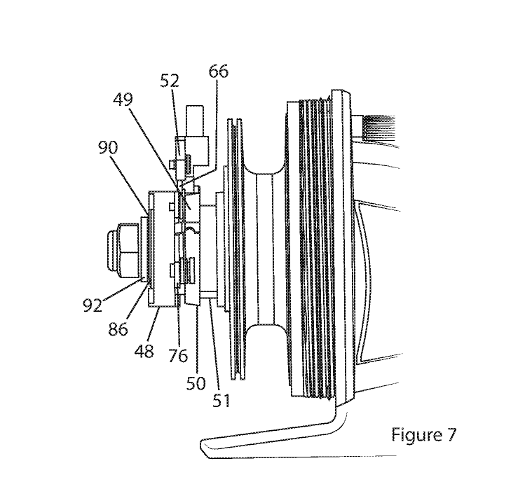

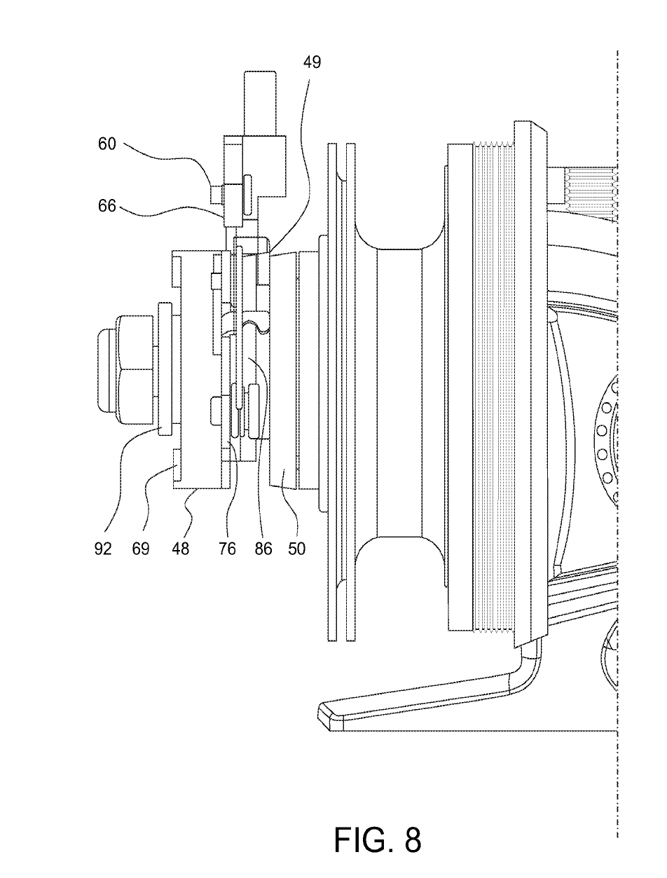

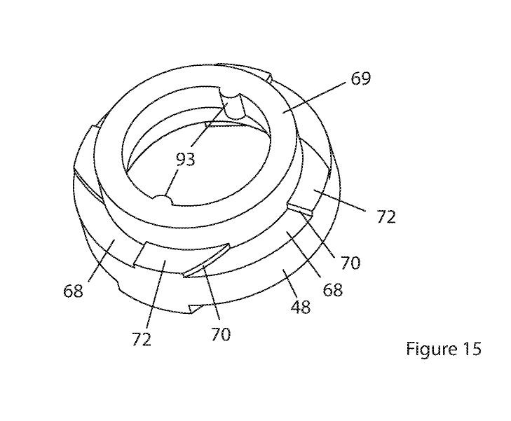

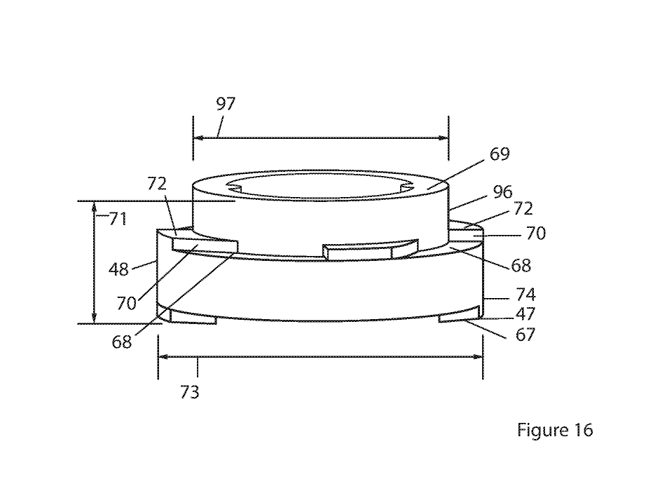

In operation, the inventive reel can be described as having an initial starting position (FIGS. 6, 9, and 12), a mid-position to hold the line in preparation for a cast (FIGS. 7, 10, and 13), and a second, casting position (FIGS. 8, 11 and 14). In the initial starting position, pickup pin 42 extends out of slot 44. This positioning of the pickup pin 42 occurs when first protrusion 66 of pickup armature 52 engages the outside surface 74 of camming control member device 48 (described in more detail in FIGS. 15-16). The positioning of the first protrusion 66 against the outer surface 74 maintains the radially outward position of the pickup pin 42 through the slot 44. In this first position, a second protrusion 83 of the second pickup armature 76 can also engage the outside surface 74 of camming control member device 48. The camming control member device 48 and the camming support 50 are both axially spaced from the clip 90.

To prepare for a cast, an angler depresses the press surface 26 of activation button 22. This moves thumb armature 24 which then engages connection bracket 56. Connection bracket 56 translates forward a distance within the frame with assistance from bracket guides 57 and engage connection rod 54 which then presses on camming support 50. Camming support 50 includes a connection rod aperture 51 that is sized and shaped to accept connection rod 54 (see FIG. 14). The movement of connection rod 54 moves camming support 50, which in turn moves camming control member device 48. The movement of connection bracket 56, connection rod 54, camming support 50, and camming control member device 48 are along, and/or substantially parallel with, the axial direction of the center shaft 36. Camming control member device 48 is displaced sufficiently forward towards clip 90 that protrusion 66 extends below shelves 68 and cams 72 but remains radially extended due to contact with camming support 50.

When the angler releases activation button 22 to allow line to unspool, camming support 50 retracts backward under the effects of rod return spring 55 and no longer obstructs protrusion 66 thereby allowing pickup armature 52 to pivot radially inward under the effects of a spring bias and retract pickup pin 42 out of engagement with fishing line from spool 40 which then unwinds from spool 40.

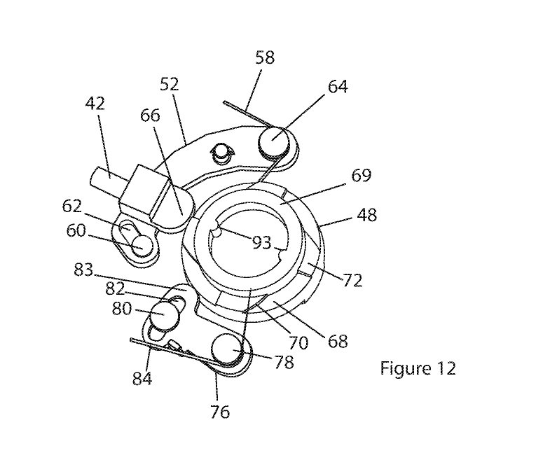

FIGS. 6-14 show different views of the first, intermediate, and second operational positions of pickup armature 52 and positioning armature 76. Starting position 1 is shown in FIGS. 6, 9, and 12. Please note that the perspective of FIGS. 12-14 is from the rear of camming control member device 48 so that the portion of camming control member device 48 that extends away from the viewer is towards the front of the reel when camming control member device 48 is installed in reel 10.

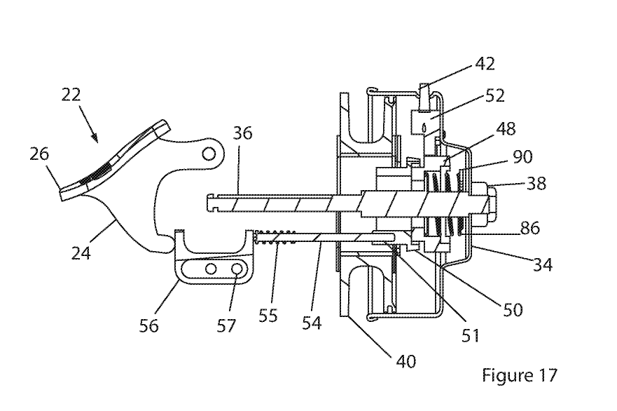

As described above, when the activation button 22 is depressed by a user connection bracket 56 and connection rod 54 (FIG. 17) axially move camming support 50 forward relative to central shaft 36. Camming support 50 engages camming control member device 48 and pushes it axially forward toward the inside surface of pickup head 34 and toward clip 90 to a mid-position. (See FIGS. 7, 10, and 13.) Pickup head 34 and pickup pin 42 do not substantially move in an axial direction as camming support moves from position 1 to the mid-position. This positioning can be described as a first position for the pickup head 34 and the pickup pin 42 and a mid-position for camming support 50 and camming control member device 48.

When this axial movement of camming support 50 and camming control member device 48 occurs, head 49 of camming support 50 is moved axially forward to a position where it engages rear of first protrusion 66 of pickup armature 52 to maintain the radial position of the pickup armature 52 and, in turn, the first position of the pickup pin 42 extending from the slot 44. (See FIGS. 7, 10, and 13.)

The outside diameter of the rear end of head 49 is substantially equal to the outside diameter of the head 47 of the camming control member device 48. The forward end of head 49 has a somewhat smaller diameter than the rear end of head 49 so as to form a sloping outer surface that facilitates the forward axial displacement of camming support 50 with pickup armature 52. This size similarity substantially retains the position of the pickup armature 52 and, in turn, the pickup pin 42 in the extended position due to interaction with the first protrusion 66.

In the mid-position or pre-casting shown in FIGS. 7, 10 and 13, camming control member device 48 is displaced so that second protrusion 83 of the second pickup armature 76 is substantially adjacent shelf portion 68 or adjacent one of the cams 72 of the camming control member device 48. In other words, second protrusion 83 is displaced radially inwards between camming control member device 48 and camming support 50. Protrusion 66 is displaced to a position beyond camming surface 72 of camming control member device 48 and against camming support 50.

Once the pressure is released from the activation button 22, camming support 50 moves axially backward so that pickup armature 52 pivots radially inward due to the effects of a biasing element 58 and/or any pressure from the fishing line 16 so that first protrusion 66 moves radially inward from just beyond camming control member device 48 and engages the rearward shelf portion 68 or cams 72 of head 47 of camming control member device 48. (See FIGS. 7, 10, and 13.) This location of the pickup pin can be described as the second or casting position with pickup pin 42 in a retracted position below the outer surface of pickup head 34 so that fishing line 16 can unwind from spool 40.

A biasing device such as cam return spring 86 is positioned to engage camming control member device 48 and biasing it towards camming support 50. A biasing device such as rod return spring 55 biases connection rod 54 and camming support 50 towards the rear of the reel. This internal positioning facilities independent return movement in an axial direction of camming control member device 48 relative to the camming support 50. For example, when activation button 22 is released rod return spring 55 moves cam support 50 backwards in an axial direction and cam return spring 86 moves camming support 48 backwards in an axial direction that is away from clip 90. However, when second protrusion 83 of the second pickup armature 76 is proximate shelf portion 68 of camming control member device 48, the axial movement of camming control member device 48 is restricted. Upon release of activation button 22, cam return spring 55 facilitates movement of camming support 50 while second pickup armature 76 restricts axial movement of camming control member device 48 to its mid-position.

This movement of the camming support 50 and general non-movement of the camming control member device 48 provides space for the first protrusion 66 of the pickup armature 52 to move radially inward, which causes the pickup pin 42 to move radially inward to the second position. The interrelationship of these parts in this spaced form with the retracted pickup pin 42 can generally be described as a second or casting position in which fishing line unwinds from spool 40.

This movement of the pickup armature 52 effectively retracts the pickup pin 42 into the second position such that it is retracted within the slot 44, wherein the fishing line 16 can be unwound from the spool 40. During this movement, the rod return spring 55 facilitates the return of the activation button 22, connection bracket 56, connection rod 54, and camming support 50 to the pre-depressed position, or the position corresponding to the first position of the pickup-pin. The camming control member device 48 is maintained in the axially forward position, a position toward the opening 25 as moved by the camming support 50, by the first protrusion 66 of the pickup armature 52 that has engaged the shelf portion 68 of the head 47.

This movement of the camming support 50 back to the first position, or the position before the activation button 22 was pressed, can also in turn move the activation button 22, connection bracket 56, and connection rod 54 to their positions before the activation button 22 was pressed.

Once the preferred amount of fishing line 16 unwinds from spool 40, which is typically based upon the casting preferences of the angler, crank handle 18 is turned to discontinue the unwinding process. Central shaft 36 is connected to the crank handle through crank armature 20 and rotates as crank handle 18 turns. Pickup head 34 is attached to central shaft 36 at fastener 38 and also turns as crank handle 18 rotates thereby causing pickup armature 52 to rotate. This rotation causes first protrusion 66 to traverse shelf portion 68 into contact with angled cam face lip surface 70 of one of cams 72 so that first protrusion 66 and pickup armature 52 are forced radially outward by pivoting about pin 64 which then moves pickup pin 42 out of slot 44 where it can once again engage the fishing line 16 for winding of fishing line 16 about spool 40. With this movement, pickup pin 42 is once again in the first position and engaged with fishing line 16. Likewise, second pick-up armature 76 is also returned to its first position by one of the cams 72. Cam return spring 86 moves camming control member device 48 rearward to its initial position thereby causing first protrusion 66 of pickup armature 52 to remain in its radial outward position and pickup pin 42 in its extended position.

In the first position, first protrusion 66 rests on the outside surface 74 of head 47 of camming control member device 48. In this position, protrusion 66 will traverse the outside 74 of camming control member device 48 as crank handle 18 is turned and will maintain the pickup pin 42 outside the pickup head 34. This location of the pickup pin 42 will again collect the fishing line 16 around the spool 40 as the crank handle 18 is turned. Once this fishing line 16 is collected to the desired level, a user can stop turning crank handle 18, and, if so desired, push thumb button 22 to recast fishing line 16 wherein the process of the mechanical system 46 begins again.

In operation, preferably the angler does not perceive a difference in the casting experience between the conventional reel and the currently disclosed reel. For example, in both reels when the button is depressed and held, no fishing line exits the reel. Once the button is released, the fishing line can exit both reels. When the crank handle is activated, or rotated, the fishing line will be retracted back into both reels.

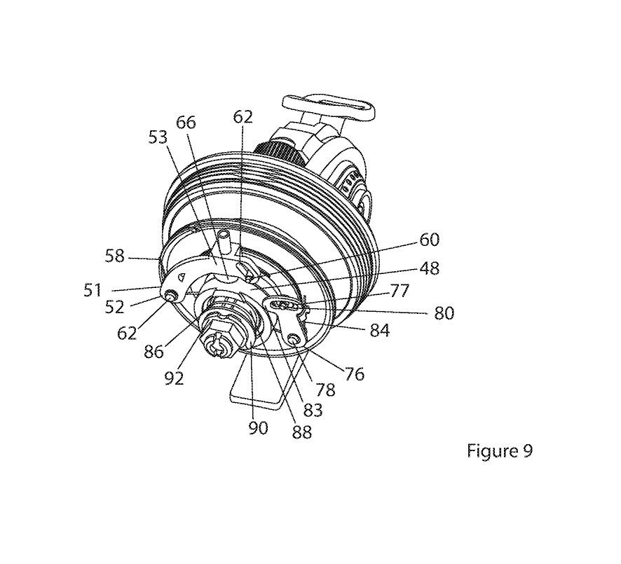

Camming control member device 48 is shown in greater detail in FIGS. 15-16. Camming control member device 48 is generally annular in shape and exhibits a forward end 67, rearward end 69, overall height 71, and outside diameter 73. Axial movement guides 93 are located within the open center of the annular camming control member device 48 so that they engage grooves 91 in retaining head 92 (FIG. 9).

The overall height 71 of camming control member device 48 is split into at least three axial portions. The first portion 94 extends axially forward from rearward end 69 for a first distance 95 forming first outer surface 96 of first diameter 97 that is radially smaller than outside diameter 73.

The second portion 98 is located on the axially transverse shelf surface 99 formed by the radial length difference between first diameter 97 and outside diameter 73. On transverse shelf surface 99, a plurality of cams 72 are formed, each with an angled ramp surface 70 from first surface 96 to outside diameter 73. In FIGS. 14-17, four cam surfaces 72 are formed on shelf surface 99. Between each cam 72 and angled ramp surface 70 is a shelf portion 68. The interactions between first protrusion 66 and second protrusion 83 with shelf portions 68, angled surfaces 70 and cams 72 are important to the positioning of pickup pin 42 when a user is winding and casting fishing line with the reel.

The third portion 99 extends from shelf surface 99 to forward end 67 and including outside surface 74. The radial position of outer surface 74 keeps pickup pin 42 in the extended, line-winding position.

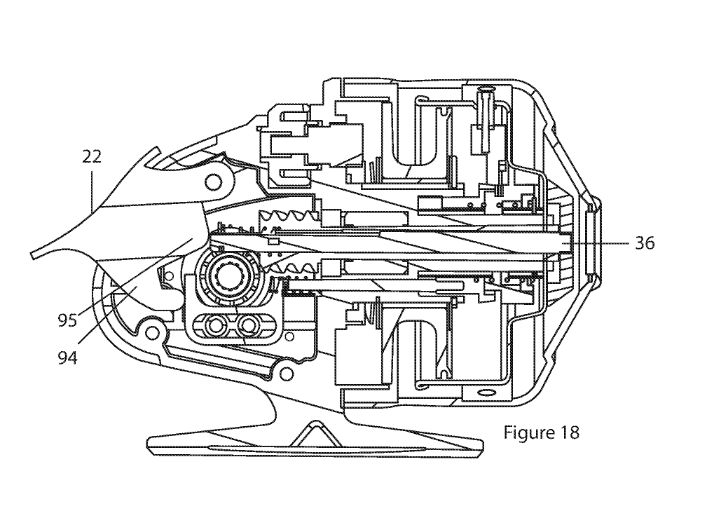

Alternate embodiments of a reel made in accordance with the current disclosure can be seen in FIGS. 18-21. In these embodiments, the inventive reel 10 can be similar, or the same, as previously described but the reel can include a shaft activation device 94. The shaft activation device 94 is designed and positioned to facilitate generally axial movement of the central shaft 36 when activation button is pressed. This axial movement can be an additional technique to control the fishing line. For example, during the casting process but before the crank handle is turned, an angler may sometimes desire to slow or stop the unwinding of the fishing line during the cast itself. After releasing the thumb button to cast the line and without turning the crank handle, the angler can re-engage the thumb button such that the shaft activation device 94 can move the central shaft 36, which in turn can move the restricting device 89 to engage the fishing line 16 to slow or even stop its movement. The restricting device 89 could be designed to either contact the inside of the front cone, or limited only to reduce the area that the fishing line 16 passes through. In either case, the angler could control the interaction of the device by how far the angler pushes the activation button 22.

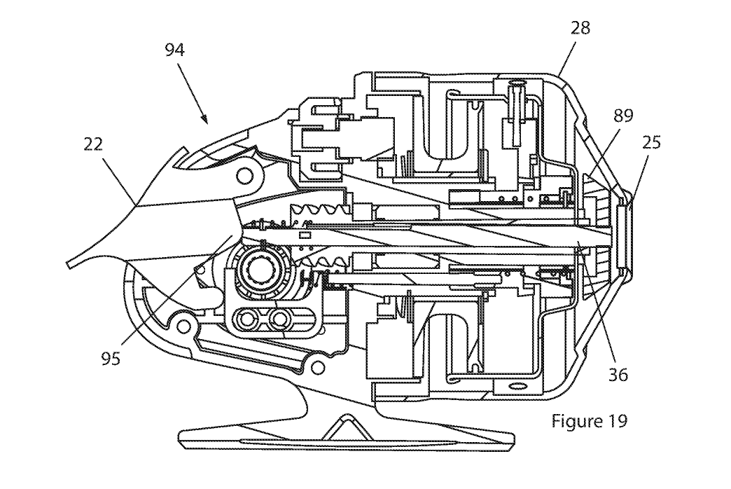

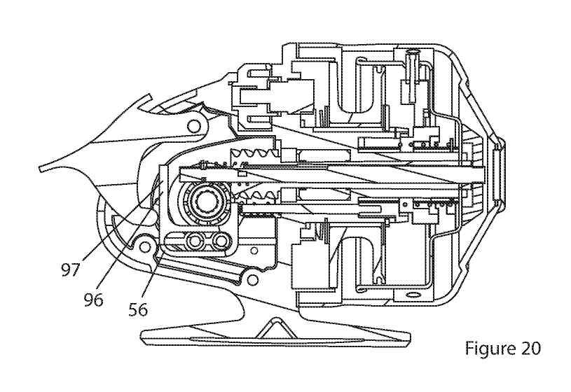

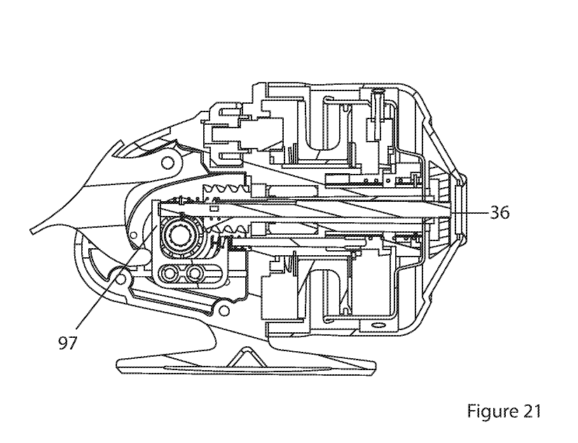

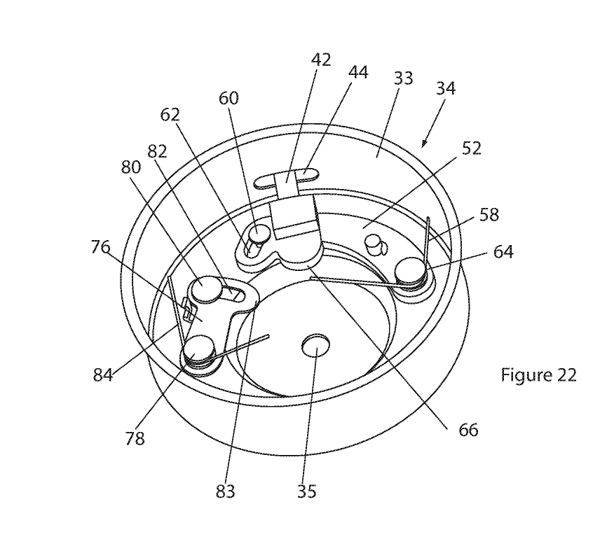

The shaft activation device 94 can be a mechanical interaction between the activation button 22 and the central shaft 36. This interaction can be by direct or indirect contact between the activation button 22 and the central shaft 36. For example, the shaft activation device 94 can include a cam surface 95 that is part of activation button 22. This cam surface 95 can directly engage the central shaft 36 as shown in FIGS. 18-19. Alternately, the shaft activation device 94 can include a mechanical link 96 that facilitates the force transfer between the activation button 22 and the central shaft 36. For example, the connection bracket 56 can include an armature 97 that can be positioned to engage the central shaft 36 to move the central shaft 36, as best seen in FIGS. 20-21.

Thus, it is seen that the apparatus and methods disclosed herein achieve the ends and advantages previously mentioned. Numerous changes in the arrangement and construction of the parts and steps will be readily apparent to those skilled in the art, and are encompassed within the scope and spirit of the present disclosure.

What is claimed is:

1. A casting system for a spincast reel, the system comprising a frame
a spool connected to the frame for holding fishing line;
a central shaft operably connected to a crank handle and configured to rotate around an axis;
a pickup head operably and rotatably mounted to the central shaft,
a pickup pin positionable between a first, radially extended position and a second, radially retracted position, where the pickup pin in the first position will engage fishing line to prevent the fishing line from unwinding from the spool when the rotor is not rotating and wind the fishing line onto the spool when the rotor is rotating, and where the pickup pin in the second position allows the fishing line to unwind from the spool;
a thumb button operatively attached to the frame and linked to the pickup pin by a mechanical system comprising a camming control member that is able to maintain the pickup pin in the first position when the thumb button is pressed forward; and allows the pickup pin to move to the second position when the thumb button is released.

2. A reel according to claim 1, wherein said mechanical system further comprises
a camming support that is operably connected to the activation button to axially displace toward a forward end of said reel and thereby axially displace said camming control member device forward.

3. The reel of claim 2, wherein said mechanical system further includes a connection rod operatively connecting the activation button and the camming control member device, said connection rod being biased in a backward direction toward said activation button.

4. The reel of claim 3, wherein said mechanical system further includes a connection bracket operatively connecting the activation button and the connection rod.

5. The reel of claim 2, further including a camming support operatively positioned between the activation button and the camming control member device, the camming support positioned to transfer a displacement force between the activation button and the camming control member device.

6. The reel of claim 2, wherein activation of the activation button operatively moves the pickup pin from a first position where the pickup pin extends from the pickup head to a second position where the pickup pin is substantially positioned within the pickup head, and movement of the crank handle moves the pickup pin from the second position to the first position.

7. The reel of claim 6, wherein activation of the activation button moves the camming control member device relative to the pickup pin and maintains the pickup pin in the first position.

8. The reel of claim 6, wherein activation of the crank handle moves the pickup pin relative to the camming control member device and operatively moves the pickup pin from the second position to the first position.

9. The reel of claim 6, further including a pickup armature attached to the pickup head and the pickup pin, the pickup armature positioned to move the pickup pin from the first position to the second position.

10. A snubberless spincast reel comprising:
a. a camming control member device exhibiting a generally annular shape having a forward end (67), a rearward end (69), an overall height (71), and an outside diameter (73), the overall height exhibiting at least three axial portions in which:
i. a first portion (94) extends axially forward from a rearward end (69) for a first distance (95) that forms a first outer surface (96) of a first diameter (97) that is radially smaller than said outside diameter (73);
ii. a second portion (98) that is located on an axially transverse shelf surface (99) that is formed by a radial length difference between said first diameter (97) and said outside diameter (73), said second portion exhibiting at least one cam surface (72) that is formed with an angled ramp surface (70) from said first outer surface (96) to said outside diameter (73), and between each said at least one cam surface (72) and said angled ramp surface (70) is formed a shelf portion (68); and
iii. a third portion (99) that extends from said shelf surface (99) to a forward end (67) thereby forming an outside surface (74) of a diameter;
b. a first, radially pivotable, pickup armature (52) exhibiting a radially inward protrusion (66) and comprising a radially outwardly extending pickup pin (42); and
c. a second, radially pivotable, pickup armature (76) exhibiting a second radially inward protrusion (83).

11. A spincast reel according to claim 10, in which said each said at least one cam surface, angled ramp surface and shelf of said camming control member device are axially positioned and radially dimensioned to interact with said first and second pickup armatures to radially extend and retract said pickup pin when a user operates said reel to wind line into said spool and cast line from said spool.

12. A spincast reel according to claim 11, further comprising:
d. an activation button (22) that pivots substantially parallel to a crank shaft (36) in said reel,
e. a pickup head (34) exhibiting an opening (44) through which a pickup pin (42) can extend to engage a fishing line passing over said pickup head, and
f. connecting linkages (56, 54) that, when the activation button is depressed and is axially displaced forward, axially displace said camming control member device (48) from a first position in which the pickup pin (42) is radially extended when said first and second pickup armatures are supported by the outer surface (74) of the third portion of said camming control member device to a mid-position in which said first pickup armature is supported by the outer surface (74) of the third portion of said camming control member device and said second pickup armature radially pivots toward said crank shaft by biased interaction with said camming control member device.

13. A spincast reel according to claim 12, wherein release of the activation button causes said button (22) to pivot axially backward and said camming control member device to move axially backward whereby said first pickup armature (52) pivots radially inward toward said crank shaft by biased interaction with said camming control member device and said pickup pin (42) is radially displaced toward said crank shaft below an outer surface of said pickup head (34).
